(19) United States
(12) Patent Application Publication
(10) Pub. No.: US 2003/0218684 A1
(43) Pub. Date: Nov. 27, 2003

(54) Imaging apparatus

(75) Inventors: Shuichi Horiguchi, Yokohama-shi (JP); Takayoshi Hasegawa, Yokohama-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 10/442,452

(22) Filed: May 21, 2003

(30) Foreign Application Priority Data
May 22, 2002 (JP) P. 2002-147893

(51) Int. Cl. H04N 5/225

(52) U.S. Cl. 348/335

(57) ABSTRACT

Providing imaging apparatus which can secure a wide angle of view with minimized distortion aberration thereby allowing the face of a person shot to be identified off the position right in front of the imaging apparatus or from a reasonably high location

Imaging apparatus according to the invention is characterized by comprising: a first reflector having a light inlet made in the center, the reflector reflecting an external light and having a convex specular surface; a second reflector for reflecting a light which was reflected on the first reflector and gathering the light beams to let the light pass through the light inlet, the reflector having a concave specular surface; a lens section provided between the light inlet and imaging means, the lens section imaging the light which has passed through the light inlet on the imaging means; and the imaging means for imaging a light which was reflected on the second reflector and has passed through the light inlet and the lens section.

### BACKGROUND OF THE INVENTION

1. Field of the Invention

The present invention relates to imaging apparatus which can shoot a shot image (subject) at a wide horizontal angle of view.

2. Description of the Related Art

A variety of lenses have been developed as imaging means for shooting various subjects. For example, lenses such as a wide angle lens, a superwide-angle lens, and a fisheye lens with a horizontal angle of view exceeding 60 degrees, 90 degrees, and 180 degrees respectively have been proposed and developed.

For example, imaging apparatus 100 using a known fisheye lens is typically known having a combination of a large number of lenses 101 as shown in FIG. 5. A light which has passed through the plurality of lenses 101 is imaged by an imaging device 100A.

However, the imaging apparatus 100 using such a fisheye lens uses a combination of a large number of lenses 101 so that the depth of the lens is very large, resulting in a large depth D of the imaging apparatus.

As shown in FIG. 6, when a subject is positioned in front of imaging apparatus using this fisheye lens, its shot image 102 suffers from small distortion. In areas near the right or left edge off the position right in front of a camera, large distortion aberration produces an extremely small shot image 103 of the subject, with considerable distortion. In case the imaging apparatus is used as a monitoring camera, a person shot often remains unidentified.

As shown in FIG. 7A, in case a camera 105 with this fisheye lens attached is fixed to a high location such as a ceiling, only the area around the top 106A of the head 106 of a person under monitoring is shot as shown in FIG. 7B. This presents a problem that the face of the person cannot be identified.

### SUMMARY OF THE INVENTION

In view of the aforementioned circumstances, the invention aims at providing imaging apparatus which can secure a wide angle of view with minimized distortion aberration thereby allowing the face of a person shot to be identified off the position right in front of the imaging apparatus or from a reasonably high location.

Imaging apparatus according to the invention is characterized by comprising:

a first reflector having a light inlet made in the center, the reflector reflecting an external light and having a convex specular surface;

a second reflector for reflecting a light which was reflected on the first reflector and gathering the light beams to let the light pass through the light inlet, the reflector having a concave specular surface;

a lens section provided between the light inlet and imaging means, the lens section imaging the light which has passed through the light inlet on the imaging means; and

the imaging means for imaging a light which was reflected on the second reflector and has passed through the light inlet and the lens section.

This makes it possible to provide a wide angle of view and identify the face of a person off the position right in front of the imaging apparatus or from a reasonably high location.

The imaging apparatus according to the invention is characterized in that the first reflector has a rotation-symmetrical aspherical surface.

This minimizes distortion aberration and provides a wide angle of view.

The imaging apparatus according to the invention is characterized in that the first reflector is formed by coating a reflective film on a curved surface formed through resin molding.

This simplifies the process of forming of the first reflector of the imaging apparatus.

The imaging apparatus is characterized in that the first reflector and the lens-barrel of the lens section are integrally formed through resin molding.

This simplifies the process of forming of the first reflector and the lens-barrel of the lens section.

The imaging apparatus is characterized in that the first reflector and the second reflector are integrally formed through resin molding.

This simplifies the process of forming of the first reflector and the second reflector.

The imaging apparatus is characterized in that the first reflector and the second reflector are formed in the shape of an approximate semicircle.

This provided wall-mount imaging apparatus which is mounted on a wall in absolute contact.

The imaging apparatus is characterized in that the imaging means is arranged with the center of the imaging means dislocated in a specific length in the direction of depth of the imaging means with respect to the optical axis of the lens section.

This prevents eclipse in the imaging area.

The imaging apparatus according to the invention is characterized in that the imaging means comprises a photoelectric converter and means for electronically correcting and removing the distortion of a shot image.

This allows distortion correction without providing optical correction means thus enabling a compact and lightweight design.

The imaging apparatus according to the invention is characterized in that the imaging means comprises a photoelectric converter and means for electronically panning, tilting and zooming on a subject.

This allows panning, tilting and zooming without providing corresponding mechanical or optical means.

The imaging apparatus is characterized in that the first reflector and the second reflector are integrally coupled back to back with a flat-plate support and that an electronic circuit for processing images from the imaging device is built into the support.

This provides low-profile wall-mount imaging apparatus.

### BRIEF DESCRIPTION OF THE DRAWINGS

FIG. 1A is a front view of imaging apparatus according to an embodiment of the invention;

FIG. 1B is a sectional view of the imaging apparatus in FIG. 1A taken on the section line I-I;

FIG. 2A shows an optical path in the imaging apparatus according to the embodiment of the invention;

FIG. 2B is an explanatory drawing showing the projection state of an image in the imaging apparatus;

FIG. 3 is an explanatory drawing showing the shift state of the imaging apparatus according to the embodiment of the invention;

FIG. 4 is an explanatory drawing showing the inversion state of a shot image in the imaging apparatus according to the embodiment of the invention;

FIG. 5 is an explanatory drawing showing the configuration and optical path of the lens section of a camera using a related art fisheye lens;

FIG. 6 is an explanatory drawing showing an image shot with a camera using a related art fisheye lens;

FIG. 7A is an explanatory drawing showing the state where a camera using a related art fisheye lens is mounted on the ceiling; and

FIG. 7B is an explanatory drawing showing the state of the face of a person shot with a camera using a related art fisheye lens mounted on the ceiling.

### DESCRIPTION OF THE PREFERRED EMBODIMENTS

An embodiment of the invention will be described referring to the attached drawings.

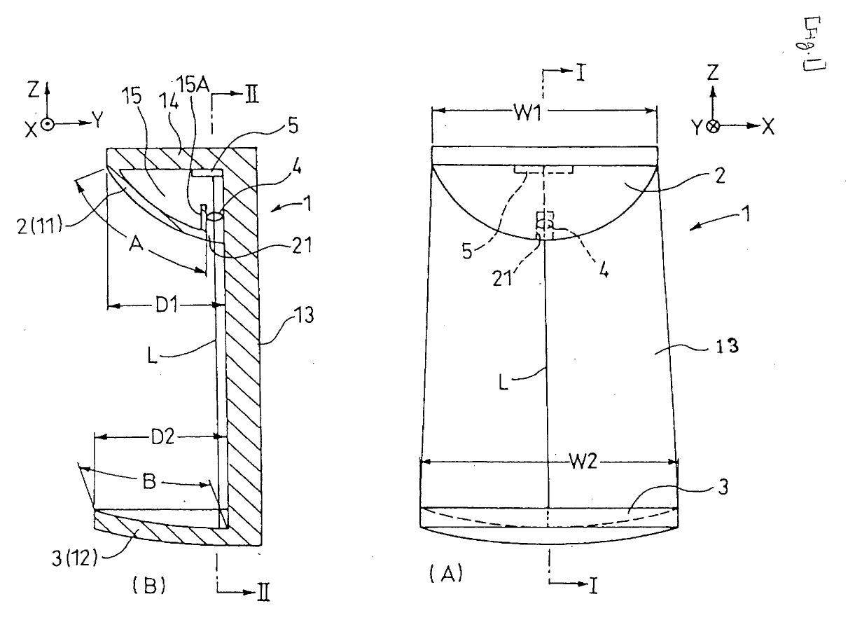

FIG. 1 shows imaging apparatus according to the invention. The imaging apparatus comprises a first reflector 2, a second reflector 3, a lens section 4, imaging means 5 and a controller (not shown) in appropriate positions outside and inside an enclosure 1.

The enclosure 1 comprises an upper protuberance 11 in an approximate quarter round sphere as a reflective surface of the first reflector 2 (its surface is not a precise sphere), a lower protuberance 12 in an approximate quarter round sphere or an approximate semicircular cylinder as a reflective surface of each of the second reflector 3, and a support 13 which couples these protuberances and whose back surface is flat in order to fix the enclosure 1 to a wall in absolute contact in a location slightly higher than the height of a person (for example approximately 2 meters from the floor) as a shooting target (subject).

In the enclosure 1 is provided a space 15 to accommodate the lens section 4 and the imaging means 5 between the upper protuberance 11 and a top surface 14. The enclosure 1 is integrally formed with an appropriate plastic resin and can be formed using a related art molding method.

The first reflector 2 comprises a light inlet 21 made in close proximity of an optical axis L and used to reflect a light from a subject as a shooting target and admitting the light. The specular surface of the first reflector 2 is in the shape of an approximate semicircle and is formed into a specific curved surface.

The first reflector 2 is designed to provide a wide angle of sight both in horizontal and vertical directions when mounted on the wall of a room in order to admit a light from a possible wide range and project and launch the light reflected on the first reflector 2 into a second reflector while minimizing the leak of the light.

The first reflector 2 is formed into a rotation-symmetrical aspherical surface whose curvature gradually varies from the edge to the center where the light inlet 21 is located, or in particular, having a smaller curvature (larger radius of curvature) toward the edge in order to assign a larger reflection angle and a larger curvature (smaller radius of curvature) toward the center. With the first reflector 2 thus configured, it is possible to shoot the surrounding in approximately all directions (180 degrees over the perimeter) without blind spots except a top (ceiling) section which rarely needs to be shot.

The reflector 2 according to this embodiment has a convex surface so as to provide a horizontal angle of view of approximately 180 degrees and a vertical angle of view of approximately 80 degrees as well as minimize the distortion of a subject.

On the first reflector 2, an appropriate reflective film, such as a thin film of a metal including aluminum and silver is coated, or a derivative multilayer film is deposited onto a surface formed, with an appropriate plastic resin, into a rotation-symmetrical aspherical surface with a required curvature. An incident light is reflected by approximately 100 percent.

The second reflector 3 reflects an external light reflected on the first reflector 2 and gathering the light beams to let the light pass through the light inlet 21. The specular surface of the second reflector 3 is formed into an approximate semicircle concave shape and a rotation-symmetrical spherical surface (or rotation-symmetrical aspherical surface) with a required curvature. The second reflector 3 is formed into a size, assumed when it is projected on a plane, slightly larger than or approximately the same as, in width and depth, the first reflector 2 projected on a plane. The support 11 of the enclosure integrally holds the second reflector 3 and the first reflector 2 with a required distance apart.

Also, on the second reflector 3, an appropriate reflective film, such as a thin film of a metal including aluminum or silver is coated, or a derivative multilayer film is deposited onto a surface formed, with the same appropriate plastic resin for integral molding with the first reflector 2, into a rotation-symmetrical aspherical surface with a required curvature. An incident light is reflected by approximately 100 percent.

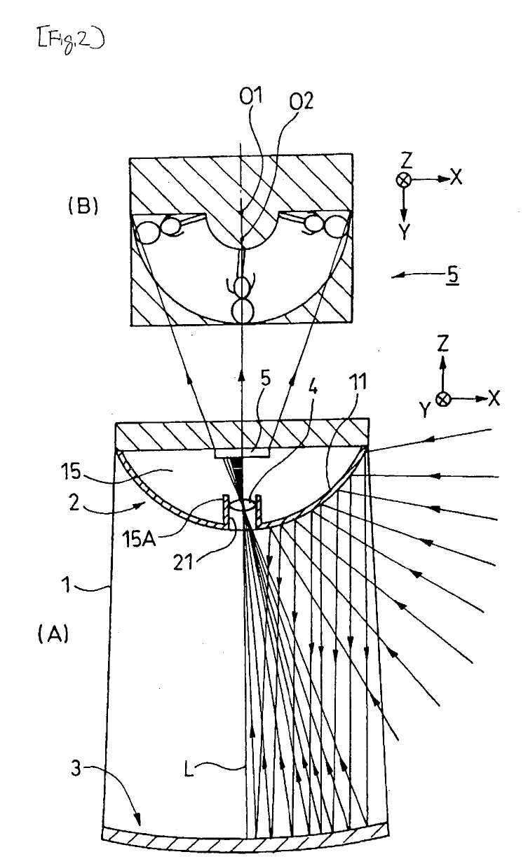

The lens section 4 forms on an imaging plane the image of a subject reflected on the second reflector 3 and admitted from the light inlet 21. The lens section 4 uses an imaging lens comprising a single lens or a combination of plurality of appropriate lenses. The image of the subject is projected upside down and reversed left to right on the imaging plane of the imaging means 5, as shown in FIG. 2 and FIG. 4.

A lens-barrel section 15A where the lens of the lens section 4 is attached is formed integrally with the enclosure 1 through resin molding, just above (in the +Z direction of) the light inlet 21 of the first reflector 1, same as the first reflector 2, as shown in FIG. 1B.

A lens used in the lens section 4 may be a glass lens or a plastic lens. Preferably, a combination of such appropriate lens is used to minimize aberration (spherical aberration and image distortion).

The imaging means 5 is arranged in parallel with a horizontal plane in the upper area of the enclosure 1 just above the first reflector 2 and the lens section 4 so that a focusing plane where the luminous flux passing through the lens section 4 is imaged will coincide with an imaging plane. The imaging means 5 is attached without the center of imaging aligned with the optical axis of the lens section 4 (corresponding to the center of the light inlet 21 of the first reflector 2) but shifted a certain amount in the back-and-forth (depth) direction. The imaging means 5 which may be a CCD (Charge-coupled Device) or a CMOS is connected to a controller (not shown) so as to output an image signal of a shot image to the controller.

The imaging means 5 according to this embodiment does not actually use optical apparatus. The controller makes control including electronic panning, tilting and zooming. The zooming function provides a crisp resolution (corresponding to 320,000 pixels) even in electronic zooming from a horizontal angle of view of 180 degrees to 60 degrees.

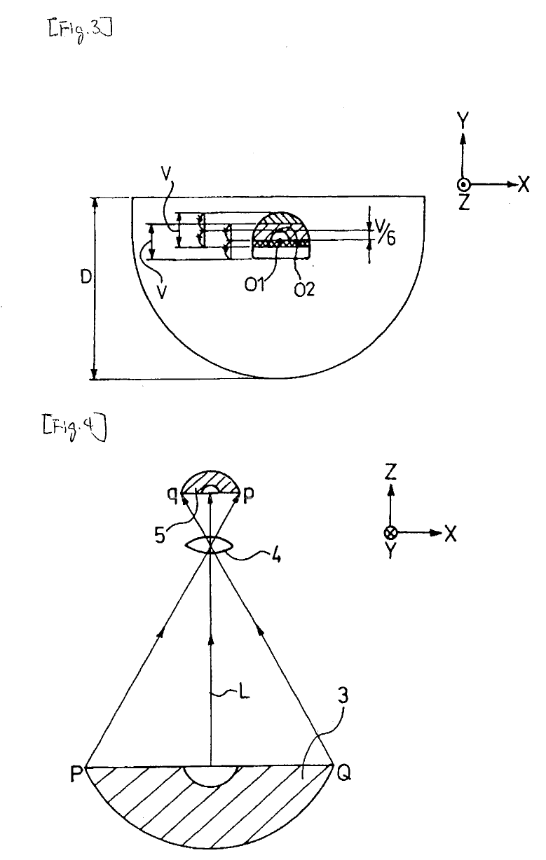

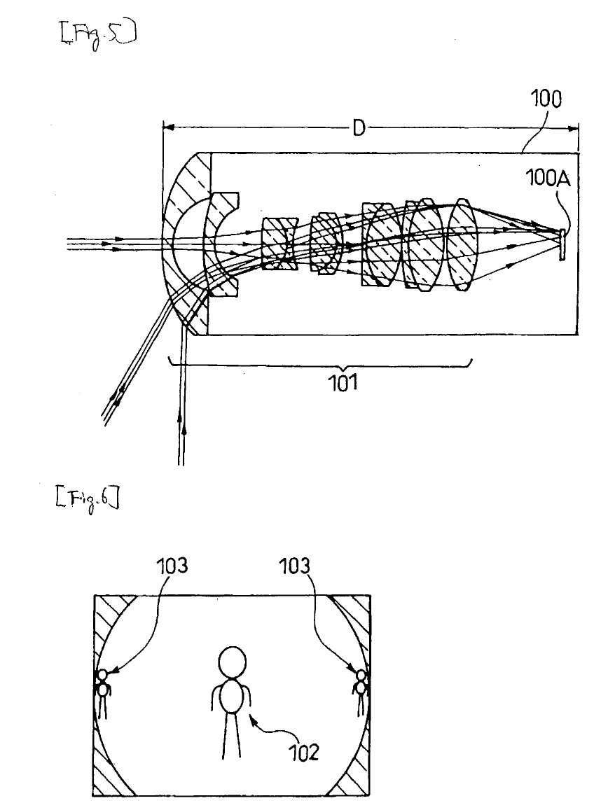

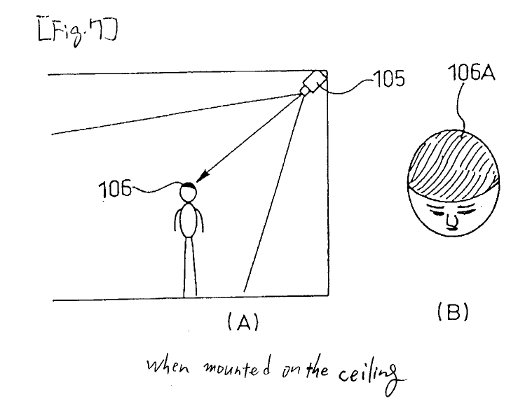

The imaging means 5 according to the embodiment uses CMOSs having 130,000 pixels formed in a rectangle and arranged horizontally, three gangs in width direction and two gangs in depth direction, so as to provide a dimension ratio of width to depth being 4:3. As shown in FIG. 3, the amount of shift (dislocation) of the optical axis L (corresponding to the center (O1) of the light inlet 21 of the first reflector 2) and the center of imaging (O2) is one sixth the depth dimension for this dimension ratio. The amount of shift is not limited to this ratio. For example, the amount of shift may be half the depth dimension in case the dimension ratio of the width to the depth is 2:1.

The center of imaging is shifted to O2 from the optical axis L (O1) in FIG. 2 and from the point O1 to the point O2 in FIG. 3 because: referring to FIG. 3, when the optical axis L is aligned with the center of imaging O, a problem is to be avoided that a hatched area shown by oblique lines ascending leftward is missing in the image information in an approximate semicircle shape to be shot in association with the reflection area of an approximate semicircle shape reflected on the second reflector 3; and a portion beyond (in the +Y direction of) the light inlet 21 (crosshatched area in FIG. 3) of the image information in an approximate semicircle shape is a non-imaging area and is conveniently deleted if possible since this area is not necessary as an area subject to imaging (effective imaging area).

The controller is mounted on a substrate (not shown) provided inside the support of the enclosure 1 and is connected to a commercial power source via a wiring (not shown either) or a battery (not shown). The controller comprises distortion correction means for electronically correcting the distortion of an image shot with the imaging means 5 and panning/tilting/zooming means for electronically forming an image of a subject shot with the imaging means through panning, tilting and zooming. Such means is well known.

Operation of the imaging apparatus according to this embodiment will be described.

The imaging apparatus is attached to a wall surface in a location slightly higher than the height of the face of a person, with the rear surface of the flat support 12 of the enclosure 1 fixed to the wall surface.

Thus, a light incident on the first reflector 2 within a wide angle range of approximately 180 degrees horizontally and approximately 80 degrees vertically excluding a ceiling and a floor corresponding to the position just above and just below the installation space of the imaging apparatus respectively is reflected on the first reflector 2 and for the most part impinges on the second reflector 3. This is because the specular surface of the first reflector is formed into a rotation-symmetrical aspherical surface having a required curvature as required.

The second reflector 3 has a specular surface formed into a rotation-symmetrical spherical surface having a required curvature. A light reflected on the second reflector 3 is reflected toward the light inlet 21 of the first reflector 2, and passing through the light inlet 21, impinges on the lens section 4 provided on the optical axis L common to the first reflector 2 and the second reflector 3.

As a result, a light refracted in and transmitted through the lens section 4 is imaged on the CMOS as imaging means 5. An imaging signal output from the imaging means 5 is input to the controller. Thus it is possible to shoot the interior of a room within a wide angle range of approximately 180 degrees horizontally and approximately 80 degrees vertically.

According to the imaging apparatus of the invention, it is possible to shoot from the front the face of a person standing in front of the imaging apparatus in a room. For a person standing off the position right in front of the imaging apparatus, for example in the right or left corner of the room, it is possible to shoot a close-up of his/her face although his/her legs appear small, which allows his/her face to be identified.

According to the embodiment, it is possible to perform zooming on a person somewhat away from the imaging apparatus arranged in a large room. Use of imaging means 5 having for example 130,000 pixels function provides a resolution corresponding to 320,000 pixels even in electronic zooming from a horizontal angle of view of 180 degrees to 60 degrees, which facilitates identification of the face of a subject.

According to the embodiment, it is possible to form almost all sections of the specular surface of each of the first reflector 2 and the second reflector 3 excluding the reflective film by way of the related art die molding method. This facilitates manufacture of the imaging apparatus.

As mentioned hereinabove, according to the invention, it is possible to provide a wide angle of view while minimizing distortion aberration. This makes it possible to identify the face of a person off the position right in front of the imaging apparatus or from a reasonably high location. Thus the invention is considerably advantageous when applied to networked cameras or a monitoring camera.

What is claimed is:

1. Imaging apparatus comprising:
a first reflector having a light inlet made in the center, said reflector reflecting an external light and having a convex specular surface;
a second reflector for reflecting a light which was reflected on said first reflector and gathering the light beams to let the light pass through said light inlet, said reflector having a concave specular surface;
a lens section provided between said light inlet and imaging means, said lens section imaging the light which has passed through said light inlet on said imaging means; and
said imaging means for imaging a light which was reflected on said second reflector and has passed through said light inlet and said lens section.

2. The imaging apparatus according to claim 1, wherein said first reflector has a rotation-symmetrical aspherical surface.

3. The imaging apparatus according to claim 1 or 2, wherein said first reflector is formed by coating a reflective film on a curved surface formed through resin molding.

4. The imaging apparatus according to claim 1, wherein c said first reflector and the lens-barrel of said lens section are integrally formed through resin molding.

5. The imaging apparatus according to claim 1, wherein said first reflector and the second reflector are integrally formed through resin molding.

6. The imaging apparatus according to claim 1, wherein said first reflector and said second reflector are formed in the shape of an approximate semicircle.

7. The imaging apparatus according to claim 1, wherein said imaging means is arranged with the center of said imaging means dislocated in a specific length in the direction of depth of the imaging means with respect to the optical axis of said lens section.

8. The imaging apparatus according to claim 1 or 7, wherein said imaging means comprises a photoelectric converter and means for electronically correcting and removing the distortion of a shot image.

9. The imaging apparatus according to any one of claims 1, 7 and 8, wherein said imaging means comprises a photoelectric converter and means for electronically panning, tilting and zooming on a subject.

10. The imaging apparatus according to any one of claims 1, 5 and 6, wherein said first reflector and said second reflector are integrally coupled back to back with a flat-plate support and that an electronic circuit for processing images from said imaging device is built into said support.
